(19) United States
(12) Patent Application Publication
(10) Pub. No.: US 2018/0014357 A1
(43) Pub. Date: Jan. 11, 2018

(54) ELECTRICALLY-CONDUCTIVE HEATING ELEMENT

(71) Applicant: General Nano LLC, Cincinnati, OH (US)

(72) Inventors: Larry Allen Christy, Cincinnati, OH (US); Edward Ming Chan, Loveland, OH (US)

(21) Appl. No.: 15/548,518

(22) PCT Filed: Feb. 3, 2016
(86) PCT No.: PCT/US2016/016380

§ 371 Date: Aug. 3, 2017

Related U.S. Application Data
(60) Provisional application No. 62/111,621, filed on Feb. 3, 2015.

(51) Int. Cl. H05B 3/14; H05B 3/03; H05B 3/26; B82Y 30/00; B82Y 40/00

(52) U.S. Cl. CPC H05B 3/145; C01B 32/158; H05B 3/03; H05B 3/26; Y10S 977/742; H05B 2214/04; H05B 2214/02; C01B 2202/34; C01B 2202/22; B82Y 40/00; B82Y 30/00; Y10S 977/753; Y10S 977/892; Y10S 977/932; H05B 2203/013

(57) ABSTRACT

A resistive heating element for use in or manufacturing of a component of an aircraft or spacecraft. The resistive heating element includes a sheet made from carbon nanotubes (CNTs) having a length of at least about 5 μιη, and formed as a nonwoven or composite polymer sheet, having good uniformity. The sheet is made with a basis weight between 1 and 50 grams per square meter (gsm), to provide a resistance value, inversely related to the basis weight, of at least about 0.01 ohms per square (Ω/□), and up to about 100 Ω/□. The CNTs can have an aspect ratio of at least about 1000:1, and at least about 10,000:1 or 100,000:1. The resistance value of the sheet can be controlled by the basis weight of CNTs, the diameter of the CNTs, and the length of CNTs, as well as chemical and mechanical treatments.

### BACKGROUND OF THE INVENTION

The present invention relates to an electrically conductive coating composition for use in preventing the icing of and actively de-icing aircraft and other substrate surfaces, and more particularly, to an electrically-conductive heating element that can be applied to a substrate surface to form a structure that is resistively heatable.

In cold weather conditions, ice may build up on the surfaces of vehicles, aircraft, and other structures. The buildup of ice on the surfaces of aircraft during flight or while on the ground is of particular concern as ice may accumulate on airfoil surfaces, radomes, engine inlets, windshields, and the like, resulting in increased weight and drag, an increased demand on engines, and decreased lift. Even a small buildup of ice on the wings and other surfaces of the aircraft can adversely affect flight stability, thus impacting safety. Current approaches for the removal of ice from commercial and military aircraft include the use of anti-icing techniques such as evaporation of water and/or water run-off, or the use of de-icing fluids such as ethylene and propylene glycol. Other known techniques utilize a combination of anti-icing and de-icing methods. However, many de-icing fluids currently in use have significant negative environmental impacts.

Other incumbent deicing technologies include copper mesh (about 160 grams per square meter (gsm)). For lightweight aircraft, e.g. an unmanned aerial vehicle (UAV), these solutions require high power (upwards of 50% upon take-offs or landings) and heavy weights. Decrease power consumption and weights are highly desirable for all-weather flights and increase flight endurance.

Another known method of ice removal includes the use of flexible pneumatic coverings, or “boots” on the leading edge surfaces of aircraft wings and control surfaces. Such boots are periodically provided with pulses of air or fluid to cause any ice accumulated on the surfaces to be cracked away and removed by action of the airstream over the surfaces. Heating elements are also known in the art which are based on nickel-coated carbon fiber mats. For example, nickel-coated carbon fiber mats capable of being heated are currently applied to aircraft propellers, wings, and rotor blades to provide a means of in-flight de-icing. Such mats are typically applied by a lay-up process and then coated with a protective coating layer. However, while such mats provide effective heating, the lay-up process is time consuming and labor intensive, and is not well suited for coating curvilinear surfaces, crevices, or angled surfaces. In addition, it is difficult to manufacture coated carbon fibers having uniform and isotropic fiber distribution which is required in order to achieve homogeneous heat distribution. Conductive paints are also known which typically comprise copper or silver filled resins. However, such paints add weight due to the use of high density metal conductive fillers. In addition, such paints may also be subject to corrosion.

Structured CNT-engineered materials have been described for use in generating heat upon an object on which it is embedded or secured, for de-icing or maintaining the object at a certain temperature, as described in US Patent Publication 2011/0240621, published Oct. 6, 2011, the disclosure of which is incorporated by reference. U.S. Pat. No. 8,146,861, the disclosure of which is incorporated by reference, provides an aircraft component having a resin matrix in which carbon nanotubes are embedded providing a high electrical conductivity, which is useful for heating up the component to defrost the component or an area adjacent to the component.

Accordingly, there is still a need in the art for a de-icing system for use on aircraft and other surfaces which is cost-effective to produce, and lightweight, and that can be applied easily to a variety of substrate surfaces, and which provides homogeneous heat distribution.

### SUMMARY OF THE INVENTION

The present invention provides a resistive heating element, and a method for making the resistive heating element, including a sheet comprising carbon nanotubes (CNTs). More particularly, the present invention provides a light-weight resistive heating element comprising a sheet of CNTs distributed uniformly within the sheet, the sheet having an electrical resistance value of at least about 0.01 ohms per square (Ω/□), including at least about 0.2Ω/□, and at least about 2Ω/□, and up to about 300Ω/□, or higher, including up to about 100Ω/□, up to about 50Ω/□, and up to about 10 Ω/□.

The invention also provides a resistive heating element, and a method for making the resistive heating element, including a sheet of CNTs, wherein the sheet resistance is tunable (adjustable) proportional inversely with the basis weight of the sheet, and with a compatible coefficient of thermal expansion with carbon fiber composites. In an aspect of the invention, the nonwoven sheet of CNTs can have a range of Ohmic resistance varying inversely with the basis weight of the CNT sheet, including with a range comprising about 0.2Ω/□ at a 20 gsm basis weight, to about 1Ω/□ at a 10 gsm.

An aspect of the present invention is a resistive heating element, and a method for making the resistive heating element, including a sheet of randomly-oriented CNTs distributed uniformly within the sheet, having a uniformity of not more than 10% coefficient of variability (COV) in order to provide uniform electrical resistivity across the area of the resistive heating element.

A further aspect of the present invention is a resistive heating element, and a method for making the resistive heating element, including a sheet of randomly-oriented CNTs distributed uniformly within the sheet, the sheet of CNTs having a basis weight of at least about 1 grams per square meter (gsm), and up to about 50 gsm, and including a basis weight of about 4 gsm to about 20 gsm.

Another aspect of the invention is a method of varying the resistance value of a CNT structure using a multitude of randomly-oriented long CNTs (having a length of at least 100 microns, and typically about 1-2 mm), formed into a layer, by varying the loading or basis weight of CNTs per unit of area of the CNT structure. The basis weight is inversely related to the resistance value.

Another aspect of the present invention is a nonwoven sheet comprising carbon nanotubes (CNTs) for use in a resistive heating element, wherein the CNTs form a continuous matrix or solid phase across the entire area of the nonwoven sheet. In this aspect, the CNTs are in direct contact with one or more adjacent CNTs along their lengths.

A further aspect of the invention is a method of making a CNT structure that provides varying electrical resistivity with loading or basis weight, using a multitude of randomly-oriented long CNTs (having a length of at least 3 microns, including at least 100 microns, and typically about 1-2 mm), formed into a layer, the basis weight of the CNT structure formed between 1 grams per square meter (gsm) and 50 gsm, including a basis weight of a value or within a range therebetween, providing the CNT structure with a respective resistance value ranging from about 100Ω/□ to about 0.1Ω/□, including a resistance value of a value or within a range therebetween.

The multitude of long CNTs can be comprised of single-walled carbon nanotubes (SWCNT) or multi-walled carbon nanotubes (MWCNT), including few-walled and double-walled CNTs. The CNTs have a high aspect ratio of at least about 1,000:1, including at least about 10,000:1, at least about 100,000:1, and at least about 1,000,000:1.

A resistive heating element can comprise a structural CNT network comprising a CNT sheet for use in a component of an aircraft or spacecraft. The resistance value of the CNT sheet can be controlled and tuned by selection and adjustments in the basis weight of CNTs, the diameter of the CNTs, and the length of CNTs, conductive or non-conductive fillers, as well as chemical and mechanical treatments.

Another aspect of the present invention is a nonwoven sheet comprising carbon nanotubes (CNTs) for use in a resistive heating element, wherein the CNTs form a continuous matrix or solid phase across the entire area of the nonwoven sheet. In this aspect, the CNTs are in direct contact with one or more adjacent CNTs along their lengths.

Another aspect of the present invention is a CNT/polymer composite film comprising carbon nanotubes (CNTs) and thermoplastic or thermoset for use in a resistive heating element, wherein the CNTs are mixed with the thermoplastic or thermoset resin, and optionally a solvent, then made into a film. In this aspect, the CNTs are in direct contact with one or more adjacent CNTs along their lengths, allowing for percolation current transport within the CNT/polymer matrix.

A further invention includes a resistive heating element comprising CNTs in use on a component of an aircraft or spacecraft, and a means by which an electric current is produced in the heating element in order to heat the heating element, in order in particular to deice the component and/or an area adjacent to the component. This produces a suitable heating power when current flows through the heating element to emit heat.

### BRIEF DESCRIPTION OF THE FIGURES

FIG. 1 shows the electrical resistance values for nonwoven CNT sheets made according to the invention based upon basis weight.

FIG. 2 shows the electrical resistance values for nonwoven CNT sheets formed using single-walled CNTs, and multi-walled CNTs.

FIG. 3 shows electrical resistance values for CNT sheets made with blends of ‘short’ CNTs into longer CNTs.

FIG. 4 shows electrical resistance values for CNT sheets made with an additive material (PVA).

FIG. 5 shows electrical resistance values for CNT sheets made at increasing basis weight for pretreated CNTs.

FIG. 6 illustrates a sheet comprising carbon nanotubes (CNTs).

FIG. 7 illustrates a sheet comprising CNTs and a porous substrate or carrier material.

FIG. 8 illustrates a sheet comprising a CNT/polymer matrix.

### DETAILED DESCRIPTION OF THE INVENTION

A resistive heating element includes a sheet comprising carbon nanotubes (CNTs). For use as a heating element on a component of an aircraft or spacecraft, the invention provides a light-weight resistive heating element comprising a sheet of randomly-oriented CNTs distributed uniformly within the sheet, the sheet having a resistance value of at least about 0.1 ohms per square (Ω/□) and up to about 100Ω/□. A uniformity of the resistive heating element should be not more than 10% coefficient of variability (COV) to provide uniform electrical resistivity across the entire area of the resistive heating element.

It has been found that CNTs having a longer length have a significant and direct effect on the formation of a non-woven sheet of randomly-oriented CNTs dispersed and inter-tangled in a layer, having a uniform resistance value across the area of the CNT nonwoven sheet. Structurally and resistively uniform CNT nonwoven sheets can be formed from CNTs having a length of at least 100 μm, which can include CNTs of a length between about 1 mm and about 2 mm.

The resistive heating element can include at least two conductive leads embedded there within or upon for applying a current to and across the resistive heating element. In another embodiment of the invention, a substrate can comprise a one or more CNT sheets.

The resistive heating element is preferably resistively heated by applying voltage to the film of at least 1 volt, including between about 5 volts (V) and about 240 V. The method may further include heating the film to a temperature in use of between about 20° C. and about 400° C. Because the resistive heating element contains CNTs which are electrically conductive, when voltage is applied, the resistive heating element emits heat which aids in removing ice from or which prevents ice buildup on a substrate surface comprising the resistive heating element.

The CNTs for use in the resistive heating element include single-walled or multi-walled carbon nanotubes, including double-walled and few-walled varieties. Single-walled, double-walled and multi-walled carbon nanotubes have a high aspect ratio of at least about 1,000:1, including at least 10,000:1, at least 100,000:1, and at least 1,000,000:1. The aspect ratio is the length of a tube to its diameter. The CNTs are sufficiently long, and uniformly positioned in a layer within the CNT sheet, to achieve a uniform resistivity across the entire area of the resistive heat element. The CNTs are also sufficiently dispersed, or mixed and interlaced with non-conductive materials such as hydrophobic polymers, to maintain low conductivity and high resistivity. The amount of CNTs in the resistive heating element can vary from about 0.01 wt %, up to about 50 wt %, including from about 0.05 wt % to about 5 wt %.

Because the resistive heating element is sufficiently electrically conductive due to the presence of the electrically-conductive CNTs, the resistive heating element can be heated by passing electrical current through the structure such that the resulting resistive heating melts ice present on the substrate surface and/or retards ice formation. In an aspect of the invention, the carbon nanotubes (CNTs) comprised in the nonwoven sheet form a continuous matrix or phase across the entire area of the nonwoven sheet, where the CNTs are in direct contact with one or more adjacent CNTs along their lengths. The flow of electricity through the matrix of CNTs is both along the lengths of the CNTs, and from a CNT to an adjacent CNT at the contact points of their junction.

Typically, the resistive heating element exhibits a sheet resistance of at least 0.1Ω/□, and up to 100Ω/□, including at least about 0.4Ω/□, and including at least about 5Ω/□, and up to about 50Ω/□, including up to about 10Ω/□. Alternatively, the sheet can have a resistance value between about 0.4 to 100Ω/□, including about 1 to 10Ω/□, about 1 to 50Ω/□, and about 10 to 100 Ω/□.

One method for adjusting or tuning the sheet resistance for high resistance applications includes reducing the amount of conductive material (CNT powder ingredient) present, thereby providing a low-basis-weight CNT nonwoven sheets. However, as the basis weight is reduced significantly, particularly with CNTs significantly shorter than 100 microns, the uniformity is compromised, along with the sheet's mechanical properties. CNTs having a length of about 10 microns and less, yield a CNT sheet with low uniformity and that is, itself, non-freestanding (not handleable).

Generally, consistent uniformity and electrical resistance values are reliably achieved when using CNTs having a length of at least about 100 microns. The electrical resistance value of the CNT nonwoven sheet is related inversely to the basis weight. A sheet of such CNTs typically has a basis weight of at least about 1 grams per square meter (gsm), and up to about 40 gsm, providing a sheet resistance value of at least about 0.1 ohms per square (Ω/□) and up to about 50 Ω/□.

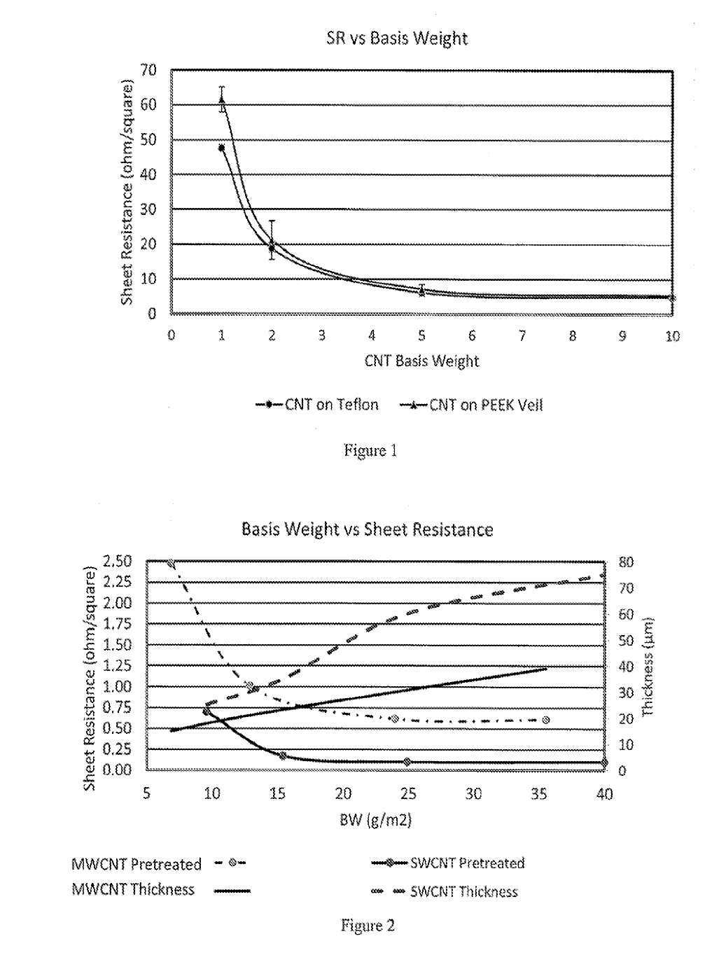

FIG. 1 shows the relationship between basis weight and sheet resistance values for two types of nonwoven CNT sheets formed on a Teflon scrim, a polyether ether ketone (PEEK) scrim, or a polyester veil scrim. FIG. 1 shows that these nonwoven CNT sheets, which are typical of CNT sheets made according to the methods described herein, using untreated single wall CNTs (SWCNTs) or multiwall CNTs (MWCNTs), have an electrical resistance value of less than 10 ohms at a basis weight of at least about 4 grams per square meter. The length of the CNTs used to form these CNT sheets is at about 0.1 mm (100 microns), including at least 0.2 mm, which can include at least about 0.5 mm, which can include a length from about 1 mm to about 2 mm.

FIG. 2 shows the relationship between basis weight and sheet resistance values for nonwoven CNT sheets formed using single-walled CNTs. In general, a nonwoven CNT sheet formed using only single-walled CNTs (which can include some small portion of double-walled CNTs) has an electrical resistance value that is roughly an order of magnitude lower than a nonwoven CNT sheet formed using only multiwall CNTs (MWCNTs, for example, about 6 walls on average), with the same basis weight and substantially the same CNT lengths (although comparable though different processing conditions might be used). It is believed that the number of individual single-wall CNTs is much larger than the number of MWCNTs at an equal basis weight, and that a larger number of CNTs produce a larger number of CNT/CNT junctions in the path of electrical flow. This results in a nonwoven CNT sheet with an observably lower sheet resistance.

U.S. Pat. No. 7,459,121, incorporated herein by reference in its entirety, describes a method for making a network of nanotubes or other nanoscale fibers. Co-pending US provisional application 62-030,860, filed Jul. 30, 2014, the disclosure of which is incorporated by reference in its entirety, describes a continuous method of making a network of carbon nanotubes (CNT), including a long and continuous structure, including a CNT nonwoven sheet.

A sheet can be also be formed using a blend of distinct CNTs or graphene. The sheets can be made from a blending of two, three or more of different sources of CNTs. For example, one source of CNTs can be distinct from another source of CNTs, without any limitation, by the length, the aspect ratio, the diameter or number of walls, the method of making of the CNTs, and by a chemical treatment as described herein.

A CNT/polymer film can be formed by mixing CNTs in a polymer resin. This can be done by mixing the CNTs in melting thermoplastic material; for example, using a twin-conical mixer to compound CNT/polymer pellets. These pellets can then be extruded into a film to form the resistive heating element. Additionally, a solvent can be used to dissolve a thermoset or thermoplastic resin, and CNTs can be mixed into the polymer/solvent solution until the desired dispersion is achieved. A high shear mixer can be used or, if a highly dispersed CNT/polymer matrix is desired, sonication can be used for mixing the CNTs into the polymer/solvent solution. A film can then be formed from the CNT/polymer/solvent solution by various methods including, but not limited to, spray coating, slot die, gravure, rid, roll, gap/knife, or dip coating, and dried (to drive off the solvent). Alternatively, the solvent can be driven off (e.g. with an oven); the remaining CNT/polymer material can then be processed into film (e.g. using hot melt coating or extrusion). Example resins include, but are not limited to, polyimide, polyvinylidene fluoride (PVDF, such as Kynar™), polyetherimide (PEI), polyamide, poly-acrylonitrile butadiene styrene (ABS), polyphenylene sulfide (PPS), polystyrene (PS), polycarbonate (PC), polylactic acid (PLA), polyether ether ketone (PEEK), polyetherketoneketone (PEKK), fluorinated ethylene propylene (FEP), and polyvinyl alcohol (PVA).

Making of CNT Sheets

CNTs sheets can be made by a number of processes, including a process for making wet-laid nonwovens, as well as a dry-laid process. A wet-laid nonwoven can be made by a modified papermaking process. An example of a wet-laid nonwoven process includes dispersing of the CNTs in water, passing the CNT dispersion over a static or continuous-traveling screen, filtering the solution of the CNT dispersion through filtration screen, and drying of the resulting CNT web to form the CNT sheet. A description of a wet-laid process is described in PCT International Application Number PCT/US15/42911, filed Jul. 30, 2015 (Attorney Docket GNA-006 PCT), the disclosure of which is incorporated by reference in its entirety. A CNT dispersion, typically in water, is passed to a head box from where they are fed continuously into a continuous web-laying machine. The solution liquid (e.g. water) is caused to drain through the entangled plurality of CNTs and through a wire screen. The resulting wet web can be then dried to a nonwoven fabric using a convection, contact and radiation dryer. The resulting sheet 10 comprising carbon nanotubes 12 (CNTs) is illustrated in FIG. 6.

While water is a preferred dispersion liquid, other non-solvent liquids can be used to disperse and process the CNTs. As used herein, the term “non-solvent” refers to compounds in liquid form that are non-reactive essentially with the CNTs and in which the CNTs are virtually insoluble. Examples of other suitable non-solvent liquids include volatile organic liquids, including acetone, ethanol, methanol, n-hexane, ether, isopropanol, N-methyl-2-pyrrolidone (NMP), dimethylacetamide (DMAC), tetrahydrofuran (THF), acetonitrile, chloroform, dimethylformamide (DMF) and, mixtures thereof. Low-boiling point solvents are typically preferred so that the solvent can be easily and quickly removed, facilitating drying of the resulting CNT structure.

The carbon nanotubes can be provided in a dry, bulk form. The CNTs typically have an individual length of at least about 0.1 mm, including at least about 0.2 mm, at least about 0.3 mm, at least about 0.4 mm, at least about 0.5 mm, at least about 1 mm, at least about 2 mm, and at least about 5 mm. The CNTs can be single wall nanotubes (SWNT), double wall nanotubes (DWNT) or other multi-wall nanotubes (MWCNT). Typical MWCNTs have a tube diameter of about 5 to 10 nanometers. Typical SWCNTs have a tube diameter of about 1 to 2 nanometers. Examples of CNTs useful in the present invention are those disclosed in or made by a process described in U.S. Pat. No. 8,753,602, the disclosure of which is incorporated by reference in its entirety. Such carbon nanotubes can include long, vertically-aligned CNTs, which are commercially available from General Nano LLC (Cincinnati, Ohio USA).

A CNT concentration in the aqueous liquid at least 10 mg/L, and up to about 10 g/L, facilitates dispersion and minimizes agglomeration of the CNTs in the dispersed solution. In various embodiments of the invention, the CNT concentration is at least about 500 mg/L, and at least about 700 mg/L, and up to about 5 g/L, up to about 1 g/l, and up to about 500 mg/L. The CNTs can be added to a quantity of the liquid under mixing conditions using one or more agitation or dispersing devices known in the art, which can include sonication equipment, high shear mixing, and microfluidic mixing techniques, or mixture thereof.

The filter material is a flexible, resilient sheet material having pores or openings that are sufficiently large to allow the dispersion liquid to be drawn therethrough with a moderate amount of vacuum or pressure, though are sufficiently small to prevent the multitude of dispersed CNTs from passing through. The size of the openings (circular, square, or any other shape) are typically about a size between about 0.1 micron, and up to about 10 micron, and the porosity (open area) is typically about 20% to about 80%, including about 30%, about 40% or about 50%. The material of the filter material is preferably non-soluble in and non-absorbent of water, and can include both hydrophilic materials, including nylon, and hydrophobic materials, including Teflon®. Hydrophilic or hydrophobic coatings, as applicable, can also be applied to a base structure of the filter material. The filter material is also referred to herein as a scrim. The length can be a spool or roll of material, or a continuous loop of material, depending upon whether the resulting CNT nonwoven sheet is removed from the scrim continuously following drying at the same production site, or is processed remotely. The loaded filter material is then passed over a mesh screen (typically a stainless steel) through a vacuum zone which draws the liquid away from the entangled CNTs and through the openings in the filter material. Uniformly distributed CNTs will appear as a uniform, black material surface across the entire width thereof. Typically the CNT sheet structure has a uniformity of not more than 10% coefficient of variance (COV), wherein COV is determined by a conventional method. Selection of vacuum box dimensions of length and width, and the distribution and size of the openings in the wire mesh can be optimized as needed for different CNT lengths and CNT nonwoven sheet bases weights.

Optionally, a porous substrate or carrier material can be used to improve the mechanical properties of the CNT sheet material or add other functionality to the structure. The size of the openings (circular, square, or any other shape) of candidate carrier materials are typically about a size between about 0.1 micron, and up to about 5 mm. The length can be a spool or roll of material. The carrier material is allowed to pass over a mesh screen (typically a stainless steel), with or without the filter material through a vacuum zone which draws the liquid away from the entangled CNTs and through the openings in the carrier material and, optionally, filter material. This couples the CNT nonwoven layer to the carrier material.

Uniformly distributed CNTs will appear as a uniform, black material surface across the entire width thereof. Typically the CNT sheet structure has a uniformity of not more than 10% coefficient of variance (COV), wherein COV is determined by a conventional method. Selection of vacuum box dimensions of length and width, and the distribution and size of the openings in the wire mesh can be optimized as needed for different CNT lengths and CNT nonwoven sheet bases weights.

The desired basis weight of the resulting CNT structure is affected by several parameters, including process conditions, apparatus, and the materials used. Generally, the larger the basis weight required, the higher the required CNT concentration, and/or the larger the dispersed liquid loading, and/or the larger the vacuum zone area, and/or the higher the vacuum applied, and/or the slower the linear speed of the filter material over the vacuum zone. All of these parameters can be manipulated to achieve the desired characteristics of the CNT nonwoven sheet, including its thickness and porosity.

The basis weight of the resulting CNT sheet can be at least 1 grams of the “longer-length” CNTs per square meter (gsm), including at least 1 gsm, at least 2 gsm, at least 3 gsm, at least 4 gsm, at least 5 gsm, and at least 6 gsm; and not more than 40 gsm, including not more than 15 gsm, not more than 12 gsm, not more than 10 gsm, not more than 8 gsm, and not more than 6 gsm; and can be about 3 gsm, about 4 gsm, about 5 gsm, about 6 gsm, about 7 gsm, about 8 gsm, about 9 gsm, about 10 gsm, and about 15 gsm.

CNT nonwoven sheets or rollstocks having very low basis weight, typically of about 4 gsm or less, are so thin that they cannot be separated from the filter material (scrim) without falling apart. CNT nonwoven sheets having very low basis weight can be separated from the filter material using a tacky substrate that itself comprises a member of a composite structure.

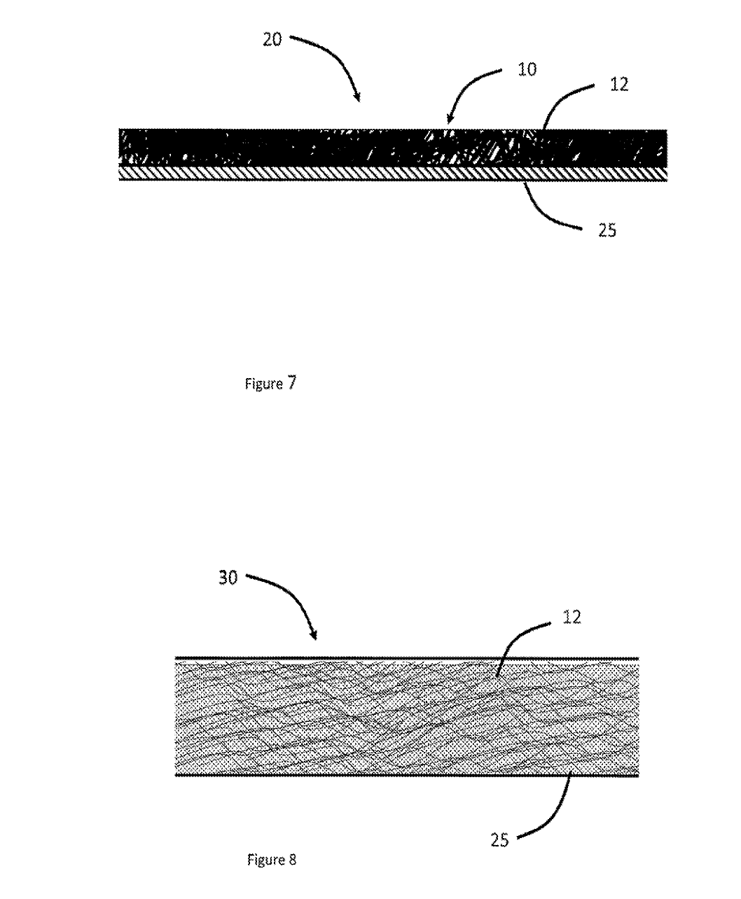

In an alternative aspect of the invention, the wet-laid CNT structures can be formed on a support carrier to form a composite sheet product to improve the mechanical properties and handling (processability) of the CNT sheet. The carrier is typically a woven fabric or nonwoven, and is typically porous and flexible. In an embodiment of the invention, the support carrier is non-stretchable or non-extensive, to limit or present stretching of the composite sheet product. FIG. 7 illustrates a composite sheet 20 comprising a structure 10 of the CNTs 12 and a porous substrate or carrier material 25.

The support carrier can be processed with the CNTs in the wet-laid process, through which the CNTs and any blended adjunct components can be vacuum formed, or can be laminated or made co-extensive with the formed CNT sheets. Examples of suitable carriers include carbon fiber nonwoven, polyester nonwoven, polyester woven, fiberglass nonwoven, expanded copper foil, copper mesh, or PEEK nonwoven.

A CNT nonwoven substrate can include a plurality of distinctly formed CNT sheets, stacked or laminated together. The stacked layers can also include filler or additive materials. Example filler materials include, but are not limited to, carbon nanofiber, graphene, glass fiber, carbon fiber, thermoplastic fiber, thermoset fiber, glass microbubbles, glass powder, thermoplastic powder, thermoset powder, nickel nanowire, nickel nanostrands, or mixtures thereof, For example, a solution containing graphene can be laid onto and coupled to a CNT nonwoven layer. Three layers of 40-gsm MWCNT sheets can be laminated into a single laminar substrate with a total basis weight of 120 gsm, a thickness of 285 vim, and a sheet resistance of 0.11Ω/□. Each individual sheet in the laminate structure, having a resistance value of 0.3Ω/□, comprises a parallel conductor with the other sheets, where the total resistance of the laminate structure is the combination of the parallel resistances (Ω/□).

Each of the laminated sheet can be formed with the same source of CNTs and process for making the sheet. Alternatively, the sheets can be made of different sources of CNTs and fillers, including without any limitation, the lengths of the CNTs, the aspect ratios of the CNTs, basis weight of the CNT sheet, the diameter or number of walls of the CNTS, and the method of making of the CNTs. Likewise, the sheets can be made without or with a chemical treatment as described herein.

Blending of Short CNTs with Long CNTs

An example of a process for producing high-resistance sheet material includes blending low-conductive adjuncts (fillers) with a low basis weight CNT powder to provide a composite low basis weight sheet with acceptable uniformity and high resistivity. Mechanical properties and handling (processability) are improved by using a low-weight carrier layer or scrim, including by example like carbon fiber veil or polyester or PEEK veil, upon which the CNT and blended adjunct components can be vacuum formed. Co-pending US provisional application 62-030,860, filed Jul. 30, 2014, describes a continuous production of a network of carbon nanotubes into a long and continuous structures or material, including a CNT nonwoven sheet. The uniformity of this process provides nonwoven CNT sheets having a sheet resistance tunable between from about 0.01 ohm to about 150 ohms, with high sheet uniformity.

Electrical resistance within the nonwoven CNT sheet structure can be affected by blending a non-conductive material, for example, polyether ether ketone (PEEK), polyimide (PI) fibers and glass fiber, including a material in particle form, with CNTs. The non-conductive fiber material can have a length up to 6 mm or more, including up to about 12 mm, above which physical entanglement of the fibers can occur during the dispersion process. Examples of additives that can increase sheet resistance of the CNT nonwoven, though typically at the expense of increased basis weight, include fiberglass flock or PEEK fibers. For example, the addition of fiberglass flock to the CNT dispersion can increase the sheet resistance of a 1.0 gsm CNT sheet from about 50Ω/□ to about 60Ω/□ (20% increase) but also increases the overall basis weight to 26 gsm. Likewise it is possible to add metallic (or other conductive) particles to the nonwoven CNT sheet to increase conductivity (decrease sheet resistance), but again at the expense of increased basis weight. The addition of a binder provides the capability of producing a freestanding, low-basis-weight CNT sheet. The addition of a binder increases the mechanical properties of the resultant nonwoven sheet to be comparable to a sheet of the binder itself. The binder, being itself nonconductive or low conductivity, increases sheet resistance. In a further aspect of the invention, the addition of the binder can result in a continuous phase of the binder, which reduces the contact points (or CNT to CNT junctions) within the CNT sheet. The binder coats or encapsulates the CNTs within the polymer or resin matrix, separating the adjacent CNTs in close proximity by a layer of the binder material. The binder results in at least a partial disruption of the continuous matrix of the CNT sheet. The flow of electricity through the matrix of CNTs can include conductivity from a CNT to an adjacent CNT in direct contact, and a reduced conductivity, or no conductivity, between the adjacent CNTs in close proximity through a layer of the binder material that separates them.

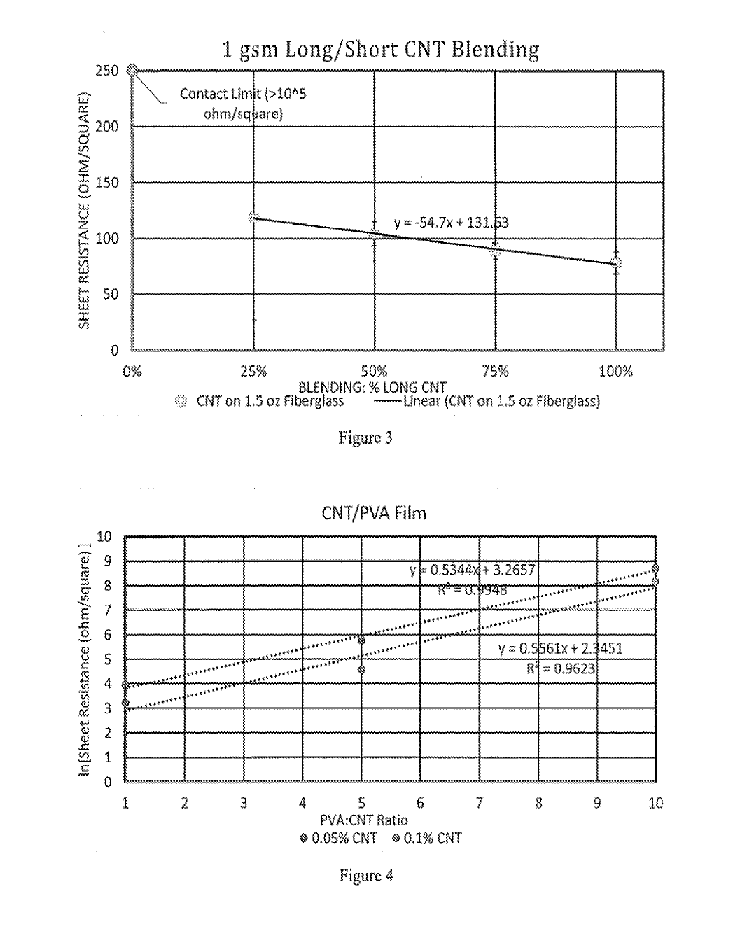

Electrical resistance within the nonwoven CNT sheet structure can also be affected by blending of a less-conductive “short” MWCNT powder material having a length from about 3 μm to about 10 μm, including a length from about 10 μm to about 100 μm, with the longer CNTs having a length of at least about 100 μm, including a length between about 1 mm and about 2 mm. The length number signifies an average weight length. FIG. 3 illustrates the effects of ‘short’ CNT blend percentage into longer CNTs upon sheet resistance for a 1.0 gsm basis weight CNT layer on a 50 gsm woven fiberglass carrier.

It is evident that increasing the ‘short’ CNT proportion increases sheet resistance linearly, but at the expense of decreased uniformity. A shorter CNT has fewer contacts with adjacent CNTs than does a longer CNT, per unit length or mass of CNTs. Comparing a sheet made from 100% longer CNT to a sheet made of a 50%/50% blend of longer and shorter CNTs, the sheet resistance increased from about 78Ω/□ to about 104Ω/□ (33% increase) with fair uniformity (about 10% COV.). However, a sheet made of a 25%/75% blend of longer and shorter CNTs had significantly decreased uniformity. A sheet consisting of short CNT also did not maintain the projected resistance when sandwiched with a resin adhesive in an aircraft component. Without being bound by any particular theory, it is believed that the resin adhesive had infused into the CNT sheet, which caused separation of short CNTs at their junctions. This resin then acts as an electrical insulator, inhibiting electron transport in the CNT nonwoven network. With short-length CNTs, these separations had a significant impact on the CNT network resistance, raising resistance and reducing conductivity.

Chemical Treatment of CNTs and Nonwoven Sheets of CNTs

Electrical conductivity within the nonwoven CNT sheet structure can be enhanced or suppressed by chemical treatment of the CNTs, prior to or after formation of the CNT sheet. An example of a chemical treatment includes an acid treatment that improves conductivity. Treatment of the bulk CNT powder with strong (nitric) acid can cause end-cap cutting, and the introduction of carboxyl groups to the CNT sidewall. Strong acid treatment may also cause protonation and oxidization of nanotube sidewalls, which afford strong hydrogen bonding among and between CNTs and hence a denser CNT packing. CNT end-cap cutting improves conductivity by improving electron mobility from the ends of the carbon nanotubes to adjacent carbon nanotubes (tunneling). A dispersion of CNTs in a low pH solution improves dispersion by positively charging, the sidewall surfaces of the CNTs, such that the like-charged CNTs repel one another. The addition of carboxyl groups to the CNT sidewalls also enhances dispersion in water by increasing the hydrophilicity of the CNTs. For example, nitric acid treated CNTs yield a 10 gsm nonwoven with sheet resistance of about 2Ω/□, compared to about 5Ω/□ for a nonwoven formed from untreated bulk CNT powder.

Another example of a chemical treatment is the addition of a large molecule onto the CNT structure which reduces the CNT-to-CNT contacts along the length of the carbon nanotubes. An example of a large molecule is an epoxide. Epoxide functionalization has been shown to increase the resistance of a 10.0 gsm CNT sheet by two-fold (from about 5Ω/□ to about 10Ω/□). Further increases in sheet resistance have been shown by adding surfactants (including sizing agents, e.g. surfactants with molecular weight 100 to 10,000 g/gmol of amphiphilicity) to the epoxide functionalized CNT dispersion which act to further separate the distance between adjacent carbon nanotubes. A 20× increase in sheet resistance has been observed with this approach, increasing the sheet resistance from about 5Ω/□ to about 100Ω/□ for a 10 gsm nonwoven. Although scalable, this approach is not trivial and is cost prohibitive.

Another example of a chemical treatment is the treatment of the CNTs with fluorine. The bulk CNT powder or CNT sheets or structures can be treated with fluorine gas. Fluorination can increase resistance of CNTs to the point of becoming electrical insulators. The process uses fluorine gas at temperatures above 250 C to create C—F bonds on the sidewalls of each individual carbon nanotubes.

Conductive or resistive particles or fibers can also be added to the CNTs to enhance or suppress electrical conductivity. In a non-limiting example, the addition of fiberglass flock to a longer CNT dispersion increased the sheet resistance of a 1.0 gsm CNT sheet (CNT basis only) from about 50 Ω/sq. to about 60 Ω/sq., and increase of 20%, while increasing the composite overall basis weight to 26.0 gsm. Of note, graphene and carbon nanofibers can be used as filler in the high sheet resistance blends (on a polyester carrier sheet) to maintain high uniformity at such low basis weights (about 2 gsm).

Small-scale (5″×5″) CNT-blended sheets on a polyester carrier have sheet resistances having high electrical resistance values that have repeatability and a COV of less than 5% (which is very uniform): 15 Ω/□, 25 Ω/□, 35 Ω/□, 45Ω/□, and 100Ω/□. The CNTs blended with graphene and carbon nanofibers, has a basis weight of about 15-20 gsm. The CNTs, graphene, and carbon nanofibers are dispersed in water and vacuum-formed onto a polyester veil. The polyester veil comprises between 60% and 90% of the total composite sheet weight and provides the bulk of the mechanical properties.

Mechanical Treatments of CNT Sheets

The mechanical properties of a nonwoven CNT sheet can be improved with the addition of a binder material into or upon the CNT sheets. Examples of a binder material include polyvinyl alcohol (PVA) or polyamide or polyimide, which provides a more chemically and thermally stable CNT/polymer hybrid sheet. Suitable thin film CNT/polymer sheets can be formed in either batch or continuous roll processes. An example using a batch casting process comprising the following: the CNT powder and PVA is dispersed, using sonication, into water and mixed until an ink-like consistency was achieved; the dispersion is then poured into a sheet mold and allowed to dry in a 100° C. vacuum oven, forming a thin film CNT/polymer sheet. The uniformity of the resulting thin film CNT/polymer sheet was measured to be about 20% COV; less than 10% is achievable with proper coating equipment.

In an example, thin CNT sheets (films) are formed using a ‘casting’ process of a CNT/PVA dispersed solution. The solution is cast into a mold of the desired dimensions (for example, about 12 inch×12 inch (about 30.5 cm×30.5 cm), and about 18 inch×18 inch (about 45.7 cm×45.7 cm)), within which the solution is allowed to dry to form a CNT/polymer matrix in which the PVA encapsulates the CNTs forming homogenous thin film. FIG. 8 illustrates a sheet 30 comprising a plurality of CNTs 12 distributed within a polymer matrix 35.

The sheet resistance can be controlled by varying the ratio of PVA to CNT, wherein a greater level of PVA results in a higher sheet resistance, and vice versa. CNT/PVA formulations typically allow for tunable sheet resistance within an estimated range of 20-5000Ω/□. An associated variable is the thickness of the film (amount of material per unit area), which will decrease sheet resistance with increased formation thickness. FIG. 4 shows the effect of PVA:CNT material ratio and CNT concentration, on the sheet resistance of the CNT/polymer thin film.

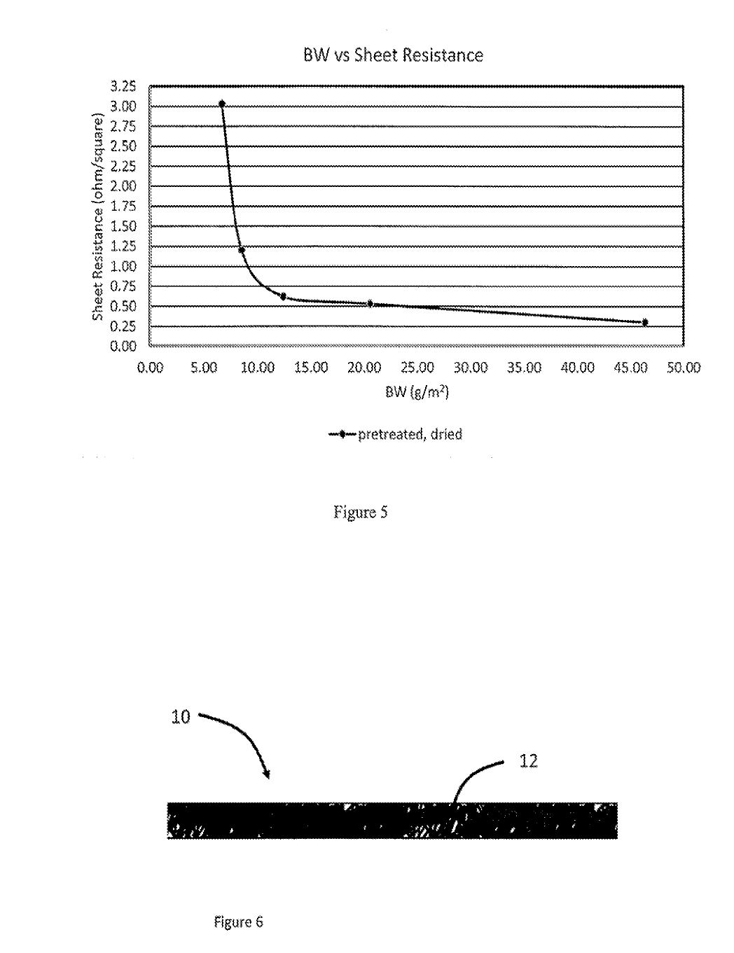

Electrical conductivity within the nonwoven CNT sheet structure can be enhanced or suppressed by mechanical treatment and processing of the CNT sheet. First, and simply, the basis weight can be increased to decrease sheet resistance (increase conductivity, at the cost and result of additional sheet weight and thickness). Empirically, the sheet resistance was found to “bottom out” at about 0.2Ω/□ with increased basis weight for a CNT sheet formed from CNTs dispersed and suspended in an acid aqueous solution (2.5 M nitric acid) for a period of at least 24 hours (see FIG. 5).

Mechanical methods for increasing electrical conductance (decreased sheet resistance) of a layer or nonwoven sheet of CNT include a method resulting in improved alignment of CNTs within the sheet, and densification of the CNT layer within the sheet. In addition, an improved dispersion of CNTs in the aqueous dispersion provides more densely packed CNTs in the nonwoven CNT sheet, and the denser CNT packing in the nonwoven sheet results in a more conductive sheet.

Another approach being investigated is oxidation of the CNT sidewall via microwave excitation. This approach is similar to acid treatment in that it allows for better dispersion, which results in a denser CNT nonwoven.

Uses of the Structured CNT Network

The CNT sheets and composite structures thereof can form at least part of a resistive heating element used as a component of an aircraft or spacecraft, or other vehicle. The CNT sheets and composite structures thereof can be attached or secured to, within or between the component or sub-component thereof, by lamination, adhesion, mechanical securement, bonding, or other means of attachment or incorporation.

A control system can be provided to deliver electrical power (current) to the structured CNT network, to generate heat. A small voltage, generally within the range of 1-10 V, can be applied across the structured CNT network (for example, across any electrode pair) to raise the temperature of the component relevantly quickly (for example, in seconds). There are many advantages to the generating heat using the CNT sheets and composite structures of the present invention. Since structural non-uniformity can disrupt both the electrical and thermal flow in a material, conventional thermographic imaging techniques may be applied, for example, to detect damage to the component or object. The structured CNT network fibers significantly enhance thermography by providing a fast internal heating source.

In another embodiment, generated heat may be used to heat the component or object or maintain the component or object at or above a selected temperature. In another embodiment, the component or object can be heated so as to heat a substance by proxy (for example, to induce a phase transition thereof) or to maintain a substance at or above a selected temperature (for example to prevent a phase transition thereof). The substance may be external to a system, for example ice buildup on an aircraft component, or internal to the system, for example fuel, coolant, or similar system. For example, this CNT resistive element can be used for anti-icing or de-icing of leading edges or engine intakes. The flexibility of the CNT sheet allows for bonding to complex curvatures, whereas traditional resistive elements cannot. The control system can be configured and/or programmed to heat the component or object to de-ice the object, or to maintain the object at or above a selected temperature to prevent icing. In some embodiment, the temperature feedback may include a temperature rate of change, for example, a heating rate of change or cooling rate of change (such as after heating), for the component or object, or for a substance heated by proxy thereof. In another embodiment, generated heat may be used to cure or bond material together. Examples include composite repair patches and out-of-autoclave composite curing.

In another embodiment, the detection system can be configured and/or programmed to determine, based on the temperature rate of change, a property or characteristic (for example, presence, amount, temperature, constitution/classification, or the like) of a substance heated by the object. For example, the detection system may be configured and/or programmed to determine a presence (or absence) of a substance, for example ice, on in or otherwise thermally coupled to the object based on, for example a temperature change rate for the object being less than a predetermined value. The detection may further be configured to determine an amount, for example a thickness, mass, volume, or the like, of the substance based on, for example the temperature change rate for the object. In some embodiments, changes in a temperature change rate may be indicative of changes in an amount of a substance. In other embodiment, a temperature rate of change may be correlated, for example, directly or indirectly, to the amount of a substance. In some embodiments, a starting temperature may be considered in conjunction with a temperature rate of change when determining the amount of a substance. Further exemplary embodiments for using temperature rate of change and experimental results are presented below.

1. A resistive heating element including a sheet comprising carbon nanotubes (CNTs), the CNTs having a length of at least about 5 μm, the sheet having a basis weight of at least about 0.5 grams per square meter (gsm), and up to about 50 gsm, and a resistance value that is inversely related to the basis weight, of at least about 0.01 ohms per square (Ω/□), and up to about 100 Ω/□.

2. The resistive heating element according to claim 1 wherein the CNTs are randomly oriented and inter-tangled in the sheet.

3. The resistive heating element according to claim 1 wherein the CNTs have a length of about 1 mm to 2 mm.

4. The resistive heating element according to claim 1 wherein the CNTs have an aspect ratio of at least about 1,000:1.

5. The resistive heating element according to claim 4 wherein the CNTs have an aspect ratio of at least 10,000:1.

6. The resistive heating element according to claim 5 wherein the CNTs have an aspect ratio of at least 100,000:1.

7. The resistive heating element according to claim 6 wherein the CNT sheet is a nonwoven sheet of randomly oriented and inter-tangled CNTs.

8. (canceled)

9. The resistive heating element according to claim 1 wherein the CNT sheet comprises a CNT/polymer film and is made by a coating process, where a solvent is optionally used to reduce viscosity to improve dispersion quality and processing.

10. The resistive heating element according to claim 7 wherein the CNT sheet is formed upon a porous substrate or carrier layer.

11. The resistive heating element according to claim 1 wherein the CNT sheet has a sheet resistance of less than 10 ohms at a basis weight of at least about 4 grams per square meter.

12. The resistive heating element according to claim 11 wherein the CNT sheet has a sheet resistance of about 5 ohms at a basis weight of at least about 6 grams per square meter.

13. A component of an aircraft or spacecraft, including a resistive heating element according to claim 1.

14. The component according to claim 13, further including at least two conductive leads embedded within or upon the resistive heating element, configured for passage therethrough of a current.

15. The component according to claim 14, wherein the resistive heating element comprises two or more said CNT sheets.

16. A resistive heating element including a sheet comprising carbon nanotubes (CNTs), the CNTs having an aspect ratio of at least about 1,000:1, the sheet having a basis weight of at least about 0.5 grams per square meter (gsm), and up to about 50 gsm, and a resistance value that is inversely related to the basis weight, of at least about 0.01 ohms per square (Ω/□), and up to about 100 Ω/□.

17. The resistive heating element according to claim 16 wherein the CNTs are randomly oriented and inter-tangled in the sheet.

18. The resistive heating element according to claim 17 wherein the CNTs have an aspect ratio of at least 10,000:1.

19. The resistive heating element according to claim 18 wherein the CNTs have an aspect ratio of at least 100,000:1.

20. The resistive heating element according to claim 18 wherein the CNTs have an aspect ratio of at least 1,000,000:1.

21. (canceled)

22. The resistive heating element according to claim 16 wherein the CNT sheet is formed upon a scrim or carrier layer.

23.-25. (canceled)
